(19) United States
(12) Patent Application Publication
(10) Pub. No.: US 2008/0066483 A1
(43) Pub. Date: Mar. 20, 2008

(54) DEVICES AND METHODS FOR PRODUCING CONTROLLED FLAVORED ICE DRINKS

(75) Inventors: Ehud Klier, Neve Yarak (IL); Yoav Heichal, Savyon (IL); Niri Klier, Savyon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: NICE VEND LTD., Savyon (IL)

(21) Appl. No.: 11/849,388

(22) Filed: Sep. 4, 2007

Related U.S. Application Data
(60) Provisional application No. 60/825,914, filed on Sep. 17, 2006.

(51) Int. Cl. A23G 9/00

(52) U.S. Cl. 62/342

(57) ABSTRACT

Device and methods for dispensing flavored ice drinks, the device including one or more containers for holding a concentrated drink, water supply, a mixing unit for mixing the concentrated drink with the water into a substantially homogeneous liquid mixture, an ice making unit assembly for freezing freshly produced liquid mixture into ice cubes containing substantially identical ice quantity, a crushing and blending unit for crushing a pre measured amount of the ice cubes into small, drinkable ice particles, and blending the ice particles with a pre measured amount of freshly produced liquid mixture. The device also includes a vessel dispensing unit for dispensing a vessel to hold the ice drink, and a computerized control unit for controlling aspects of the process of producing the ice drink.

### CROSS REFERENCE TO RELATED APPLICATIONS

This application claims the benefit under 35 USC 119(e) from U.S. provisional application 60/864,980 filed Nov. 9^{th}, 2006, the disclosure of which is included herein by reference.

### FIELD OF THE INVENTION

The present invention relates to the field of producing a drink-mixture and more particularly, the present invention relates to a novel method and device for producing a flavored ice-drink from a liquid drink and crushed ice cubes, the ice cubes being prepared ahead of time, and the liquid portion of the ice-drink and the ice portion of the ice-drink having preferably the same content and the same flavor.

### BACKGROUND OF THE INVENTION AND PRIOR ART

A common prior art method for producing ice-drinks, which can be continuously and instantaneously supplied, uses device having a liquid mixture which is chilled to a partial frozen state, while being continuously mixed. The disadvantage of the method is the short shelf-life of the mixture. Moreover, the process of preparing the ice-drink may involve manual control which has to be done by trained personal The device may not operate automatically and may need continuous supervision when an ice-drink is requested. Furthermore, the process of cooling the liquid into a ready to serve ice drink, typically takes between 20-60 minutes, during which time the ice-drink cannot be served.

Other prior art devices for dispensing ice-drinks, such as vending machines, do not have the capacity needed to ensure a non-stop supply of a large numbers of servings by a single machine. Existing vending machines suffer from a short shelf life, due to the method operation. Moreover, the vending machines offer relatively small quantities of iced drinks, thereby limiting the amount of the ice-drink servings.

Prior art devices for dispensing flavored ice-drinks do produce the flavored ice portion of the drink and the liquid portion of the drink with the same process, thereby the two portions of the drink cannot be controlled to repeatably contain the same content and thereby producing an ice drink which has substantially the same content and the same flavor.

### BRIEF SUMMARY OF THE INVENTION

The term “ice cube” as used herein refers to a frozen piece, the frozen piece including ice and possibly other ingredients and is substantially in solid form.

The term ‘crashed ice’ as used herein refers to an ice cube being crashed into slush or small particles or granule etc.

The term “ice drink” as used herein refers to a drink containing both liquid and crashed ice.

According to the teachings of the present invention, there is provided a device and methods for dispensing flavored ice drinks, the device including one or more containers for holding a concentrated materials, water supply, a mixing unit for mixing the concentrated drink with the water into a substantially homogeneous liquid mixture, an ice making unit assembly for freezing freshly produced liquid mixture into ice cubes containing substantially identical ice quantity, a crushing and blending unit for crushing a pre measured amount of the ice cubes into small, drinkable ice panicles, and blending the ice particles with a pre measured amount of freshly produced liquid mixture. The device further includes a vessel dispensing unit for dispensing a vessel to hold the ice drink, and a computerized control unit for controlling aspects of the process of producing the ice drink.

### BRIEF DESCRIPTION OF THE DRAWINGS

The present invention will become fully understood from the detailed description given herein below and the accompanying drawings, which are given by way of illustration and example only and thus not limitative of the present invention.

FIG. 1 is a schematic block diagram of the sub-system for making the frozen part of a flavored iced drink, according to embodiments of the present invention;

FIG. 2 is a schematic block diagram of the system for making a flavored iced drink, according to embodiments of the present invention; and

FIG. 3 is a schematic block diagram flow chart that outlines the successive steps of the process from purchasing till the delivery of a flavored ice drink, according to embodiments of the present invention.

FIG. 4 is a perspective view illustration of an ice cube making unit assembly, according to embodiments of the present invention.

FIG. 5 is a back perspective view illustration of the ice cube maker of the ice cube making unit assembly shown in FIG. 4.

FIG. 6 is a front perspective view illustration of an ice cube maker of the ice cube making unit assembly shown in FIG. 4.

FIG. 7 is a perspective view illustration of an ice cube conveyor of the ice cube maker shown in FIG. 5.

### DETAILED DESCRIPTION OF THE INVENTION

The present invention is a device for making a flavored iced drink having the liquid portion of the flavored iced drink and frozen portion of the flavored iced drink with preferably the same content and the same flavor. The device makes the liquid portion of the flavored iced drink and frozen portion of the flavored iced drink is controlled by a computerized control unit, thereby the resulting ice drink is substantially repeatable.

Before explaining embodiments of the invention in detail, it is to be understood that the invention is not limited in its application to the details of design and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

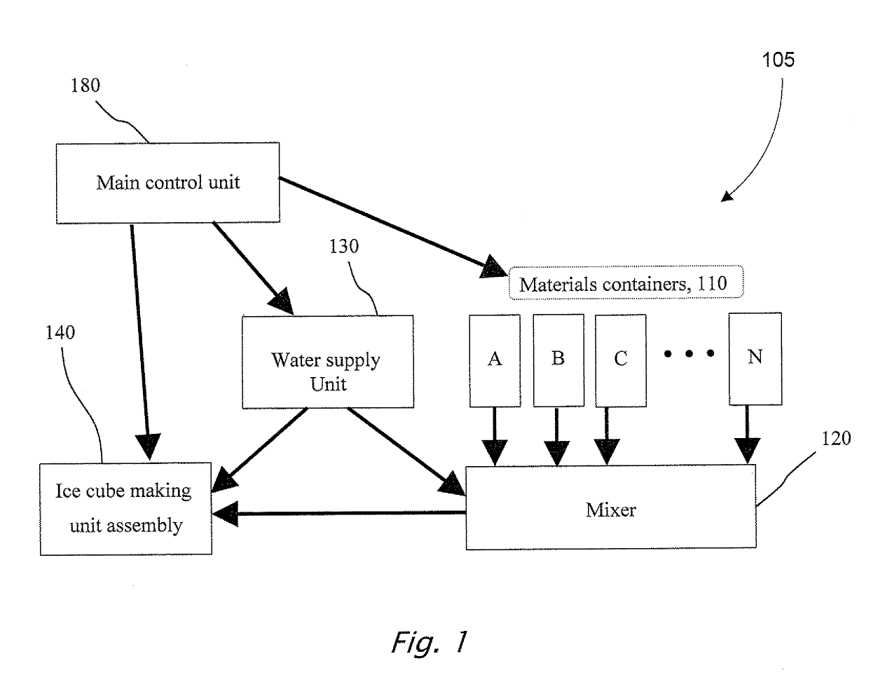

Referring now to the drawings, FIG. 1 is a schematic block diagram of the sub-system 105 for making the frozen part of a flavored iced drink, according to embodiments of the present invention. Containers 110 contain flavored concentrated materials for making flavored drinks, such as juices, coffee, chocolate and other flavored drinks. The concentrated materials can be of liquid form or preferably powder of form, which is characterized by a longer shelf life.

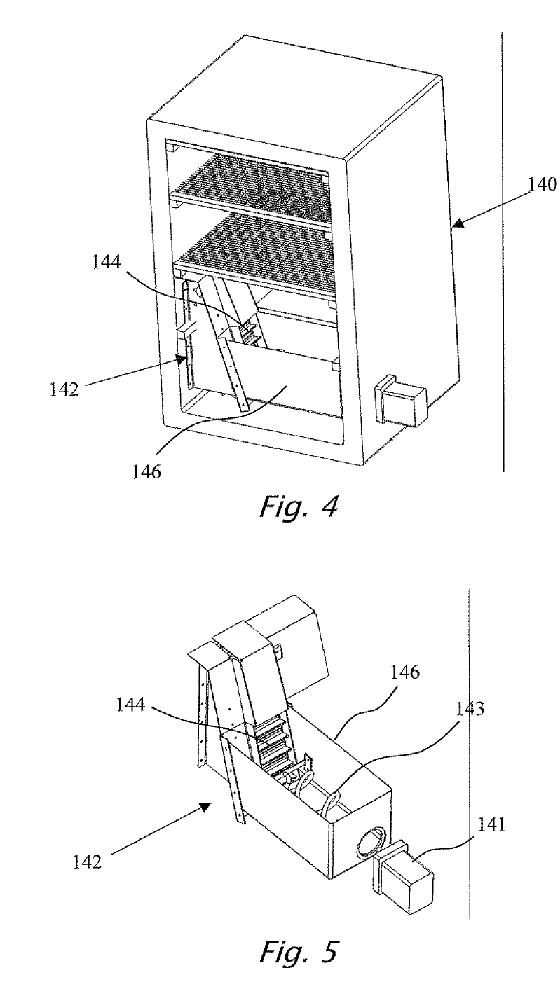

Selected concentrated materials are transferred to mixer 120 along with water from water supply unit 130, whereas the ratio between the transferred concentrated materials and the water is controlled by a computerized control unit 180. Mixer 120 mixes the mixture of concentrated materials and water which, when ready, the mixture is transferred to ice cube making unit assembly 140. Reference is also made to FIG. 4, which a perspective view illustration of an ice cube making unit assembly 140, according to embodiments of the present invention. Iced cube unit assembly 140 makes the frozen portion of a flavored iced drink. Control unit 180 identifies deficiency of ice cubes in ice cube storage 146 and initiates a process of making more ice cubes for the flavored ice drink to fill up ice cube storage 146. Keeping ice cube storage 146 filled, ensures that when device 100 is requested to provide a flavored ice drink, device 100 will have enough ice cubes to fulfill the request.

In some embodiments of the present invention, containers 110 may contain readily mixed flavored concentrated materials. For example: a concentrated mixture of coffee, sugar and milk. In other embodiments of the present invention, various containers 110 may contain one or more ingredients of the final flavored drink. For example: container 110A contains coffee, container 110B contains sugar and container 110C contains milk. Any other ingredient combination is also possible and is in the scope of the present invention.

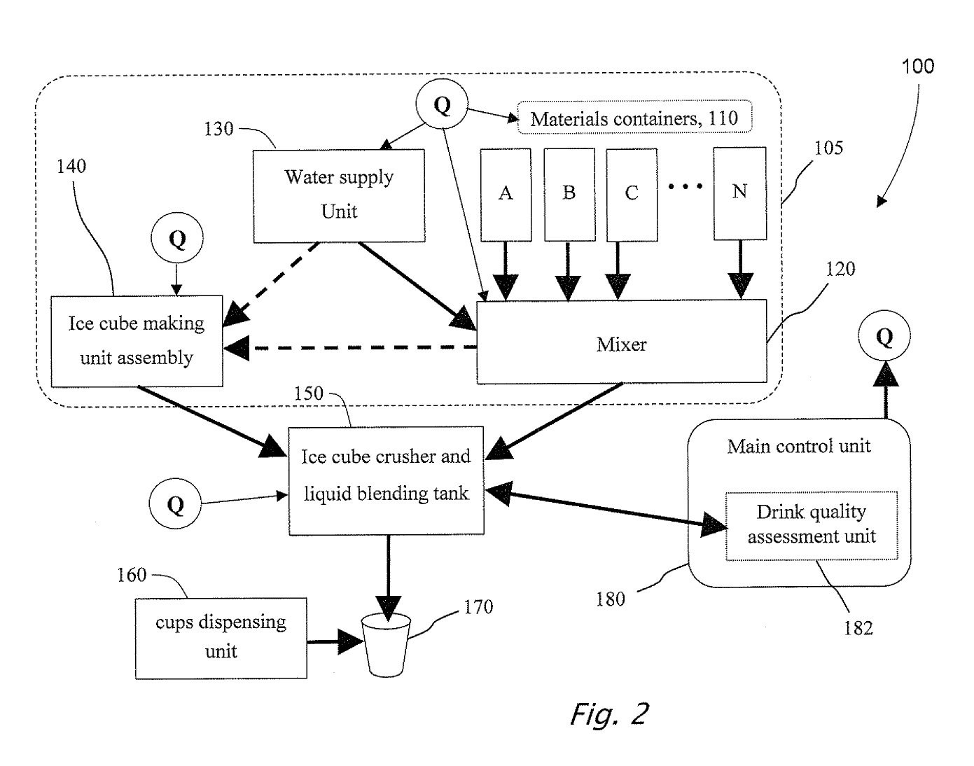

Reference is now made to FIG. 2, which is a schematic block diagram of the device 100 for making a flavored iced drink, according to embodiments of the present invention. When device 100 is requested to provide a flavored ice drink, selected concentrated materials are transferred to mixer 120 along with water from water supply unit 130, whereas the ratio between the transferred concentrated materials and the water is controlled by a computerized control unit 180. Control unit 180 also ensures that the ratio between the transferred concentrated materials and the water in the final ice drink is substantially repeatable. Mixer 120 mixes the concentrated materials and water into a substantially homogeneous mixture which, when ready, the mixture is transferred to crushing and blending unit 150 along with a pre measured quantity of ice cubes from ice cube maker 140. In blending unit 150, the pre measured quantity of ice cubes are crushed to a predetermined size crushed ice and the freshly prepared liquid portion of the flavored iced drink are mixed and served into a vessel, such as a cup 170, dispensed from cup dispensing unit 160.

In embodiments of the present invention, control unit 180 includes a drink quality assessment unit 182, which analyzes quality parameters such as the viscosity, temperature, texture, etc. of the flavored iced drink being prepared and adjust the controls, as needed, to comply with the quality required from the selected flavored iced drink.

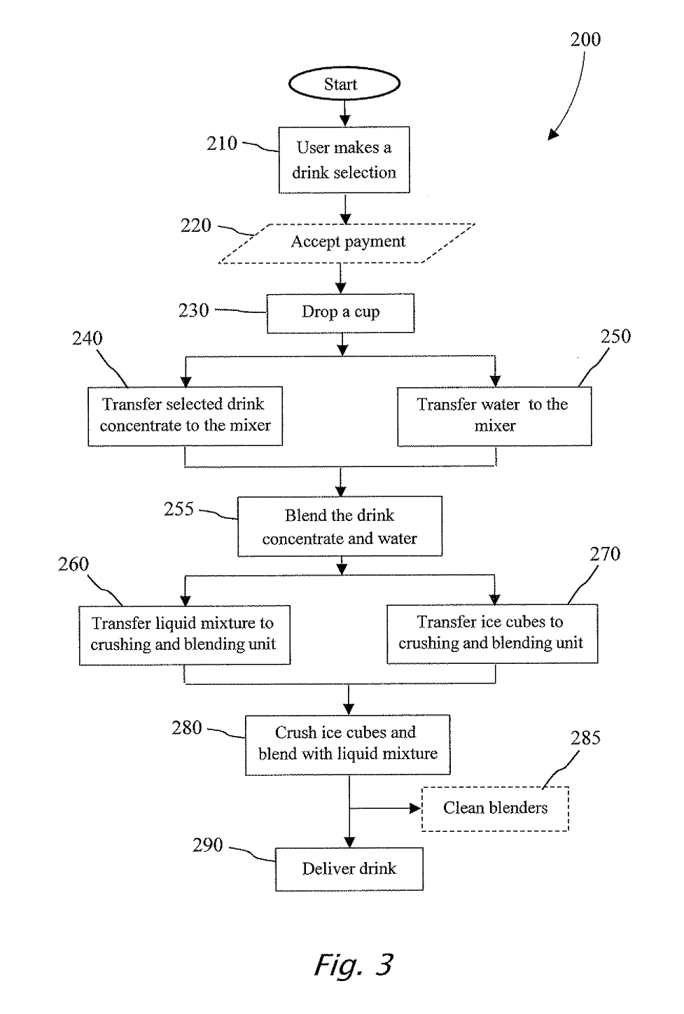

Reference is now made to FIG. 3, which is a schematic block diagram flow chart that outlines an example process 200 of preparing a flavored iced drink, from selection till delivery of the flavored ice drink, using device 100, according to embodiments of the present invention. Process 200 starts by the user making a drink selection, in step 210. It should be noted that device 100 may include just one optional ice drink, in which case step 210 is skipped. If device 100 is a vending machine, the user makes a payment, in step 220, to commence the automatic process of preparing the selected flavored ice drink. A cup 170 is dropped at a predetermined location in step 230. In step 240 the selected drink concentrate and possibly other ingredients are transferred to mixer 120, and possibly in parallel water are also transferred to mixer 120, in step 250. The selected drink concentrate and water are blended to a substantially uniform mixture, in step 255. In step 260 the freshly prepared uniform liquid mixture is transferred to crushing and blending unit 150 and, possibly in parallel, ice cubes prepared in advance and stored in ice cube maker 140, are also transferred to crushing and blending unit 150, in step 270. The liquid mixture and the ice cube are prepared in a controlled process and thereby the resulting ice drink has substantially the same content and the same flavor. The ice cubes are crashes and blended into a substantially uniform mixture, in step 280. Optionally, mixer 120 and or blending unit 150 are cleaned in step 285. The ready to serve flavored ice drink is delivered to cup 170 and to the user in step 290.

It should be noted the some steps of process 200 can be activated in a different order, for example, steps 210 and 220 can be interchanged and step 230 can be at anytime before delivering the ready to serve flavored ice drink.

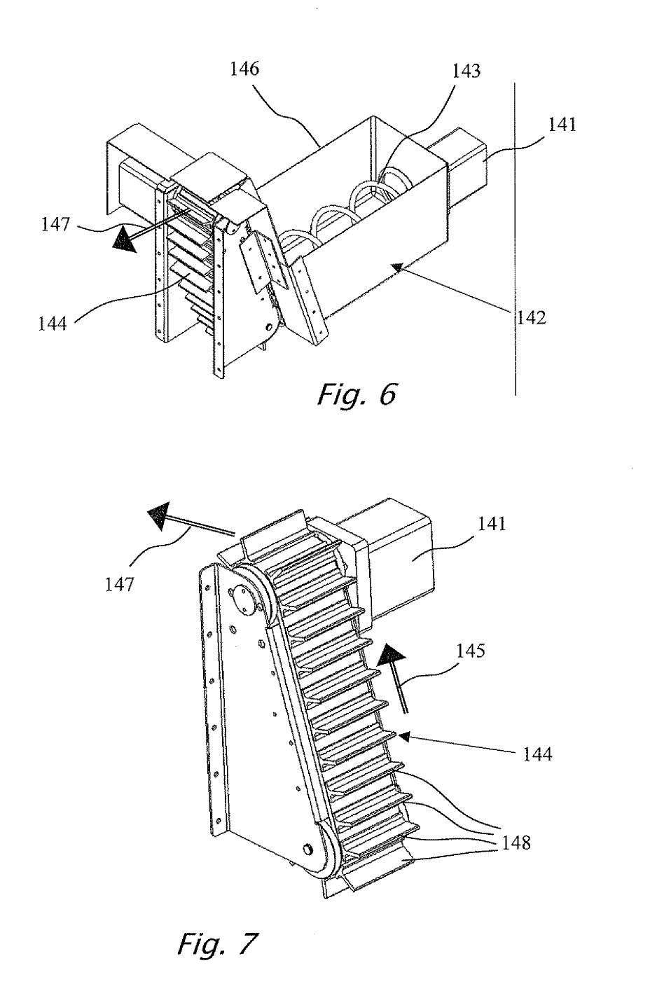

In embodiments of the present invention, ice cube making unit assembly 140 has a mechanism for accurate counting of the ice cubes being transferred to crushing and blending unit 150. Referring back to FIG. 4 an example ice cube making unit assembly 140 is shown. Reference is also made to FIG. 5, which is a back perspective view illustration of the ice cube maker of the ice cube making unit assembly shown in FIG. 4, and to FIG. 6, which is a front perspective view illustration of the ice cube maker of the ice cube making unit assembly shown in FIG. 4. In the example, ice cube making unit assembly 140 includes, ice cube maker 142 which includes a storage unit 146, an ice cube moving mechanism 143, a motor 141 for power rotating mechanism 143 and a conveyor 144. FIG. 7 is a perspective view illustration of an ice cube conveyor 144 of the ice cube maker 142 shown in FIG. 5. When conveyor 144 moves in direction 145, individual flavored ice cubes are picked be cleats 148, pushing them up and individually allowing the to proceed in direction 147 towards crushing and blending unit 150. Flavored ice cubes, moving individually, can be accurately counted as the ice cubes are moved by conveyor 144 or as the ice cubes exit from conveyor 144. The counting mechanism can be an optical sensor, a contact sensor or any sensor known in the art.

In embodiments of the present invention, the water supplied by water supply unit 130, are sparkling water.

In embodiments of the present invention, the water supplied by water supply unit 130, are other liquids such as juice, fruit juice, milk, yogurt, alcoholic beverage or any other drinkable liquid.

In embodiments of the present invention, the selected concentrated materials and other ingredients, which are transferred to mixer 120 along with water from water supply unit 130, when preparing the ice cube differ from the mixture transferred to mixer 120, when preparing the liquid portion of the iced drink being prepared. In such case computerized control unit 180 balance the final mixture of the ingredients being transferred to blending unit 150. For example, in a certain iced coffee which contains milk, the milk portion of the mixture being transferred to ice cube making unit assembly 140 contains no milk. A proper portion of the milk ingredient will be transferred to the mixture being prepared mixer 120, when the liquid portion of the iced coffee is prepared and transferred to blending unit 150. In embodiments of the present invention, the frozen portion of the iced drink being prepared contains substantially only water.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A device for dispensing flavored ice drinks, the device comprising:
(a) at least one container for holding a concentrated drink;
(b) a supply of a base liquid drink;
(c) a mixing unit for mixing said concentrated drink with said base liquid drink, thereby producing a substantially homogeneous liquid mixture;
(d) an ice making unit assembly for freezing said liquid mixture into ice cubes having substantially identical ice quantity;
(e) a crushing and blending unit for crushing a pre measured amount of said ice cubes into small, drinkable ice particles, wherein said drinkable ice particles are mixed with a pre measured amount of said liquid mixture;
(f) a vessel dispensing unit; and
(g) a computerized control unit for controlling aspects of the process of producing said ice drink.

2. The device of claim 1, wherein said base liquid drink is selected from the group of drink liquids including water, juice, fruit juice, milk, yogurt, beverage, alcoholic beverage.

3. The device of claim 2, wherein said concentrated drink contains one or more flavor ingredients of said liquid mixture.

4. The device of claim 2, wherein said concentrated drink contains all flavor ingredients of said liquid mixture.

5. The device of claim 1, wherein said ice making unit assembly comprises a storage unit for holding said ice cubes being prepared in advance.

6. The device of claim 1, wherein said ice making unit assembly comprises a transferring mechanism for transferring said ice cubes to said crushing and blending unit.

7. The device of claim 1, wherein said ice making unit assembly comprises a mechanism for counting said ice cubes being transferred to said crushing and blending unit.

8. The device of claim 1, wherein said control unit is operated to perform identifying a quantity deficiency of said ice cubes in said storage, thereby initiating a process of making more of said ice cubes.

9. The device of claim 1, wherein said control unit is operated to perform controlling the ratio of said concentrated drink and said base drink being transferred to said mixing unit.

10. The device of claim 1, wherein said control unit is operated to perform controlling the ratio of said ice cubes and said liquid mixture being transferred to said crushing and blending unit.

11. The device of claim 1, wherein said control unit is operated to perform assessing the quality of said ice drink being prepared.

12. The device of claim 1, wherein said concentrated drink is selected from the group of material forms including powder and liquid.

13. The device of claim 1, further comprising a cleaning mechanism for cleaning said mixing unit.

14. The device of claim 1, further comprising a cleaning mechanism for cleaning said crushing and blending unit.

15. A method producing and dispensing flavored ice drinks, the method comprising:
(a) holding a concentrated drink in at least one container;
(b) providing a base liquid drink;
(c) providing a mixing unit for mixing said concentrated drink with said base liquid drink, thereby producing a substantially homogeneous liquid mixture;
(d) providing an ice making unit assembly for freezing said liquid mixture into ice cubes having substantially identical ice quantity;
(e) crushing a pre measured amount of said ice cubes into small, drinkable ice particles, and blending said drinkable ice particles with a pre measured amount of said liquid mixture;
(f) dispensing a vessel for serving said ice drink; and
(g) controlling aspects of the process of producing said ice drink.

16. The method of claim 15, wherein said base liquid drink is selected from the group of drink liquids including water, juice, fruit juice, milk, yogurt, beverage, alcoholic beverage.

17. The method of claim 15, wherein said controlling of the process of producing said ice drink comprises counting said ice cubes being transferred to said crushing and blending unit.

18. The method of claim 15, wherein said controlling of the process of producing said ice drink comprises identifying a quantity deficiency of said ice cubes in said storage, thereby initiating a process of making more of said ice cubes.

19. The method of claim 15, wherein said controlling of the process of producing said ice drink comprises controlling the ratio of said concentrated drink and said base drink being transferred to said mixing unit.

20. The method of claim 15, wherein said controlling of the process of producing said ice drink comprises controlling the ratio of said ice cubes and said liquid mixture being transferred to said crushing and blending unit.

21. The method of claim 15, wherein said controlling of the process of producing said ice drink comprises assessing the quality of said ice drink being prepared.

22. The method of claim 15, wherein said concentrated drink is selected from the group of material forms including powder and liquid.
